(19) United States
(12) Patent Application Publication
(10) Pub. No.: US 2011/0040040 A1
(43) Pub. Date: Feb. 17, 2011

(54) POLYMER MIXTURE

(75) Inventors: Steffen Bornemann, Jessnitz (DE); Thomas Klausen, Peine (DE)

Correspondence Address: FISH & RICHARDSON P.C. (BO), P.O. BOX 1022, MINNEAPOLIS, MN, 55440-1022, US

(73) Assignees: FIBERWEB COROVIN GMBH, Peine (DE); FIBERWEB BERLIN GMBH, Berlin (DE)

(21) Appl. No.: 12/837,737

(22) Filed: Jul. 16, 2010

Related U.S. Application Data
(63) Continuation of application No. PCT/EP2009/000323, filed on Jan. 20, 2009.

(30) Foreign Application Priority Data
Jan. 21, 2008 (DE) 102008005466.6

(51) Int. Cl. C08L 23/06

(52) U.S. Cl. 525/240

(57) ABSTRACT

A nonwoven and a nonwoven fiber are disclosed. The fleece or fleece fiber include a polymer mixture. The polymer mixture includes a polyethyelene and a LLDPE. Various applications for the fleece are proposed.

### CROSS-REFERENCE TO RELATED APPLICATIONS

This application is a continuation of international patent application serial number PCT/EP2009/000323, filed Jan. 20, 2009, which claims benefit of German patent application serial number 10 2008 405 466.6, filed Jan. 21, 2008. The entire contents of international patent application serial number PCT/EP2009/000323 are hereby incorporated by reference.

### FIELD

This disclosure pertains to a nonwoven material with nonwoven fibers exhibiting a special polymer mixture, as well as the nonwoven fiber itself as well as a polymer mixture and applications thereof.

### BACKGROUND

In the manufacture of nonwoven fabrics, particular attention is typically paid to the source material in order to achieve the desired parameters. For this reason it is often desirable to determine by way of tests if a material is appropriate for use at all. Material data sheets of various manufacturers provide certain criteria, however, they are not suitable to provide the desired information desired for specific applications. Since the manufacture of polymers is accordingly expensive, manufacturers only provide a limited selection of polymers.

It is therefore often left to the user or the manufacture of nonwovens to determine the properties, the manufacturing method as well as the polymer composition of a suitable nonwoven material.

For cost reasons, nonwovens are often made of polyolefins. When polyethylene is used as source material, we have the known state of the art. U.S. Pat. No. 6,391,443 as well as U.S. Pat. No. 7,223,818 respectively disclose different mixtures and fields of application of the introduced polymers for nonwoven fibers. U.S. Pat. No. 6,391,443 discloses a polymer mixture exhibiting two different polyethylene components with different melting (fusion) points. While one type of polyethylene shall exhibit a density of 0.85 to 0.93 g/cm³ with a low melting point, the other polyethylene shall exhibit a density of 0.94 g/cm³ or more, and should have a high melting point. Furthermore, a specific thermal response shall occur, as represented by the DSC measurement. Nonwovens manufactured with this method shall preferably be used for medical materials and, in particular, shall be able to be sterilized with gamma radiation. U.S. Pat. No. 7,223,818 on the other hand describes polymer mixtures where a mixture of two different polyethylene is being used. Both polyethylenes shall have a specific dependency in relation to their densitites as well as in relation to their MFIs.

From the area of film (foil), WO 01/98409 A1 discloses a mixture of polyethylenes wherein one polyethylene is manufactured based on a metallocene catalyst and shall exhibit a density of less than 0.916 g/cm³.

This polyethylene is often linear without long chain scissions. The other polyethylene shall have a density of 0.94 g/cm³ or more. The polymer mixture, on the other hand, shall be especially appropriate for the manufacture of foil, in particular for the manufacture of bubble foil and cast foil. If these polymer mixtures are used to manufacture nonwovens cannot be obtained from WO 01/98409. Rather, only foil applications and methods of manufacture of different foil and foil laminates are described.

### SUMMARY

The disclosure provides a nonwoven, a nonwoven fiber and a polymer mixture for the manufacture of nonwoven fibers, which are in particular suitable for a heat-activated laminating process.

Proposed is a nonwoven with a nonwoven fiber exhibiting a polymer mixture, which as base polymer exhibits a polyethylene with an MFI between 15 and 35, preferably between 15 and 20 20 g/10 min. pursuant to ISO 1133 and a density of 0.935 to 0.965 g/cm³ according to ASTM D-792, and which exhibits as an at least second polymer an LLDPE with a density of 0.85 to 0.90 g/cm³ according to ASTM D-762.

The nonwoven material is preferably made from a nonwoven fiber of this type. Preferably, the nonwoven fiber of the nonwoven material is of the type of a so-called spunbond nonwoven. This type of fiber can be manufactured on a REICOFIL-3 or REICOFIL-4 system. Other manufacturing methods may be used as well. For example, the nonwoven may be a carded nonwoven or a nonwoven manufactured with the melt-blown process.

The nonwoven fiber preferably exclusively exhibits the base polymer and the second polymer as polymer components. The polymer mixture may furthermore contain additives like antioxidants, like flame-retardants and color pigments, UV stabilizers or other additives for the adjustment of a characteristic of the nonwoven material and the nonwoven fiber created from the polymer mixture.

Pursuant to an advanced embodiment it is provided that the base polymer is at a minimum 80 weight percent of the polymer mixture, with the second polymer contributing a weight of up to 20 weight percent of the polymer mixture. Another embodiment provides that the second polymer is a polyolefin with an MFI of 3 to 7 g/10 min per ISO 1133, and preferably a melting point in a range of 50° C. to 100° C., preferably from 50° C. to 70° C. pursuant to the DSC measurement. The DSC is measured per DIN IN ISO 11/357-1.

Furthermore preferred is a design, in which the second polymer is an ethylene/alpha-olefin copolymer. Utilized as alpha-olefin may in particular: 1-propene, 1-butene, 1-pentene, 1 hexene, 1-heptene, 1-octene, 1-decene, 1-dodecene, 1-hexadecene, 4-methyl-1-pentene, 3-methyl-1-pentene, 3-methyl-1-butene and/or 3-ethyl-1-pentene; vinylcyclohexane and terpolymers can also be used.

Further preferred is a polymer mixture composed of homo-homo- and/or copolymers-copolymers. Here as well, terpolymers can also be used.

One embodiment of a proposed polymer mixture, for example, provides the use of a polyethylene manufactured by the Dow Company under the trade name of “ASPUN 6834” as base polymer. This polymer has an MFI of 17 g/10 min per ISO 1133 at a density of 0.95 g/cm³ per ASTM D-792 and a melting point of 130° C. pursuant to the measured DSC value. This material is sold by the manufacturer as suitable for the manufacture of nonwoven fibers. Another polyethylene usable as base polymer is the polyethylene sold by the Dow Company under the trade name “ASPUN 6834A”. It has a density of 0.955 g/cm³ per ASTM D.792, an MFI of 30 per ASTM D-1238 and a DSC melting point of 131° C.

Used as the second polymer for the creation of the polymer mixture is “Affinity EH 8200”, which is marketed by the same manufacturer, DOW. According to a statement by the manufacturer, it is a polyolefin plastomer manufactured by means of an INSITE catalyst, which shall be used for the manufacture of filled floor coverings and as viscosity modifier in calandered foam layers. However, uses of this material for nonwoven fibers are not known. The polymer sold under the brand name “Affinity EG 8200” has an MFI of 5 g/10 min per ISO 1133, a density of 0.870 g/cm³ per ASTM D-792, a melting point of 60° C. per the measured DSC value, and a Vicat softening point von 45° C. per ISO 306 (Methodology A).

The effect of the second polymer on the polymer mixture to increase the capacity to expand is illustrated in Table 1 below. In this case, two different nonwoven material weights, namely 35 g/m² and 60 g/m², were analyzed with different added quantities of the second polymer to the base polymer in regard to the changes of the characteristics. We point out that the respective values resulting from these tables shall not be deemed limiting but rather be deemed to be samples. They can be used as limits to formulate different ranges. The values determined for these nonwovens indicated as samples, however, are also verifiable for other nonwoven weights as well as for interim values when adding the second polymer to the base polymer.

TABLE 1
Properties of polyethylene nonwovens from different mixtures

| | | | | | Vg | Vg | Vg | Vg | Vh |
|---|---|---|---|---|---|---|---|---|---|
| | | 2. | 2. | 2. | l.- | l.- | l.- | l.- | l.- |
| | Basis | PE 5% | PE 10% | PE 15% | PE 5% | PE 10% | PE 15% | PE 4% | PE 15% |
| 35 g/m² | 07-StB016-1 | 07-StB016-3 | 07-StB016-5 | 07-StB016-7 | 07-StB016-9 | 07-StB016- | 07-StB016- | 07-StB016- | 07-StB016- |
| | | | | | | 11 | 13 | 17 | 23 |
| 60 g/m² | 07-StB016-2 | 07-StB016-4 | 07-StB016-6 | 07-StB016-8 | 07-StB016- | 07-StB016- | 07-StB016- | 07-StB016- | 07-StB016- |
| | | | | | 10 | 12 | 14 | 18 | 24 |
| | Basis weight (g/m²) | | | | | | | | |
| 35 g/m² | 34.2 | 34.7 | 35.0 | 35.5 | 34.5 | 34.5 | 34.8 | 34.2 | 34.2 |
| 60 g/m² | 59.9 | 60.3 | 61.4 | 60.7 | 59.5 | 59.9 | 60.2 | 59.2 | 59.1 |
| | Filament titer (dtex) | | | | | | | | |
| 35 g/m² | 2.7 | 2.7 | 2.8 | 2.8 | 2.9 | 2.8 | 3.1 | 3.4 | 2.8 |
| 60 g/m² | 2.7 | 3.0 | 2.8 | 2.8 | 2.9 | 2.8 | 2.9 | 3.4 | 2.8 |
| | Thickness (microns) | | | | | | | | |
| 35 g/m² | 401 | 395 | 395 | 376 | 384 | 387 | 376 | 388 | 394 |
| 60 g/m² | 530 | 540 | 554 | 526 | 522 | 536 | 538 | 566 | 550 |
| | Tensile strength MD (N) | | | | | | | | |
| 35 g/m² | 22.8 | 20.7 | 21.5 | 24.8 | 22.2 | 21.3 | 26.0 | 17.6 | 12.2 |
| 60 g/m² | 43.0 | 37.0 | 37.3 | 50.9 | 39.3 | 35.5 | 44.6 | 33.2 | 26.2 |
| | Tensile strength CD (N) | | | | | | | | |
| 35 g/m² | 10.8 | 10.8 | 12.9 | 17.3 | 10.6 | 11.3 | 11.1 | 7.5 | 7.8 |
| 60 g/m² | 20.1 | 19.8 | 22.9 | 26.8 | 19.3 | 19.4 | 21.2 | 13.8 | 14.5 |
| | Peak elongation MD (%) | | | | | | | | |
| 35 g/m² | 48.3 | 52.8 | 74.2 | 110.3 | 50.2 | 54.5 | 70.4 | 33.6 | 33.2 |
| 60 g/m² | 50.4 | 48.1 | 59.0 | 100.2 | 49.7 | 46.8 | 62.0 | 34.9 | 36.2 |
| | Peak elongation CD (%) | | | | | | | | |
| 35 g/m² | 58.3 | 61.7 | 74.0 | 119.9 | 58.9 | 64.2 | 79.4 | 51.4 | 49.1 |
| 60 g/m² | 59.2 | 57.6 | 71.8 | 107.1 | 57.3 | 57.7 | 77.4 | 55.1 | 47.0 |
| | Bending length MD (cm) | | | | | | | | |
| 35 g/m² | 2.49 | 2.22 | 1.98 | 1.81 | 2.40 | 2.23 | 2.18 | 2.26 | 2.04 |
| 60 g/m² | 3.62 | 3.13 | 2.90 | 2.65 | 3.37 | 3.28 | 3.01 | 3.28 | 2.88 |
| | Bending length CD (cm) | | | | | | | | |
| 35 g/m² | 1.64 | 1.53 | 1.42 | 1.37 | 1.53 | 1.49 | 1.37 | 1.47 | 1.43 |
| 60 g/m² | 2.48 | 2.29 | 2.21 | 1.92 | 2.36 | 2.26 | 2.04 | 2.12 | 2.11 |
| | Flexural rigidity MD (mN * cm) | | | | | | | | |
| 35 g/m² | 0.56 | 0.39 | 0.28 | 0.22 | 0.49 | 0.39 | 0.37 | 0.39 | 0.30 |
| 60 g/m² | 2.90 | 1.91 | 1.55 | 1.18 | 2.35 | 2.14 | 1.67 | 1.85 | 1.44 |
| | Flexural rigidity CD (mN*cm) | | | | | | | | |
| 35 g/m² | 0.16 | 0.13 | 0.10 | 0.10 | 0.13 | 0.12 | 0.09 | 0.11 | 0.10 |
| 60 g/m² | 0.93 | 0.78 | 0.71 | 0.44 | 0.79 | 0.70 | 0.53 | 0.51 | 0.55 |
| | Fuzz (mg/cm²) | | | | | | | | |
| 35 g/m² | 0.718 | 0.931 | 0.753 | 0.567 | 0.855 | 0.819 | 0.812 | 0.765 | 0.803 |
| | Air permeability (l/m²s) | | | | | | | | |
| 35 g/m² | 3322 | 3604 | 3623 | 3656 | 3593 | 3690 | 3580 | 4473 | 3748 |
| 60 g/m² | 1826 | 1874 | 1938 | 1937 | 1873 | 1904 | 1930 | 2473 | 2049 |

The first column of Table 1 indicates the used nonwoven weight grammage, the second column characterizes the values measured on a nonwoven material manufactured exclusively from a base polymer, the second column the addition of 5 weight percent, the third column the addition of 10 weight percent, and the fourth column the addition of 15 weight percent of the second polyethylene to the base polyethylene. The first four columns on the left side therefore provide an overview of the response of the proposed polymer mixture when used for the manufacture of a nonwoven material in comparison to the base polymer. The nonwoven material is furthermore a spundbond nonwoven and was thermally bonded with a calander unit. On the right side of Table 1, additional different comparative mixtures were analyzed after they were also processed into spunbond nonwovens under the same manufacturing conditions. The sixth column indicates that another polyethylene was added, in particular with 5 weight percent to the same base polymer. The seventh and the eighth column reflect the results for the addition of 10 and 15 weight percent to the base polymer. Notable is in particular the increase of a value for the peak elongation in MD and CD direction and which is important for expansion, which value occurs when the proposed polymer mixture is used. Such value can also not be obtained by adding the other two polymers, once at 4 weight percent and once at 15 weight percent respectively to the base polymer. The values indicated in Table 1 were, by the way, measured with the usual measuring methods for nonwovens as suggested by Edana, for example.

The effect of the addition of the second polymer to the base polymer when creating the polymer mixture is also illustrated by the following representation of FIG. 10 from temperature measurements pursuant to DSC curves.

Based on this representation 1 in FIG. 10, the first heating has been mapped in the upper left area, and the cooling curve on the right. The lower range was mapped in the same way. While the upper two representations reflect the base polymer only, the lower part of the diagram reflects the base polymer plus an added 10% of the second polymer.

The different significant thermal characteristics of the different filaments with different second polymers are shown in Table 2:

TABLE 2
Thermal Properties of polyethylene filaments from different mixtures

| | 1st Heat | | | Cooling | | | 2nd Heat | | |
|---|---|---|---|---|---|---|---|---|---|
| | Peak | Onset | Delta H | Peak | Onset | Delta H | Peak | Onset | Delta H |
| | ° C. | ° C. | J/g | ° C. | ° C. | J/g | ° C. | ° C. | J/g |
| Base Polymer | 128.2 | 124.4 | 163.8 | 109.6 | 113.5 | −168.8 | 127.9 | 123.0 | 182.1 |
| BP + 10% Affinity EG8200 | 126.5 | 122.7 | 143.5 | 110.9 | 113.5 | −158.4 | 126.9 | 123.2 | 161.5 |
| BP + 10% VGL-P2 | 127.3 | 123.5 | 152.0 | 109.3 | 113.3 | −166.9 | 128.0 | 122.5 | 163.8 |
| Comparative Polymer 1 | 122.7 | 112.2 | 109.8 | 103.3 | 107.2 | −113.2 | 120.4 | 115.8 | 123.2 |
| Affinity EG 8200 | 67.7 | 54.8 | 5.8 | no peak | | | 68.0 | 54.8 | 6.2 |
| Comparative Polymer 2 | 96.2 | 83.6 | 49.5 | 68.3 | 72.2 | −55.5 | 95.2 | 84.4 | 57.0 |

As can be obtained from FIG. 1 and Table 2, the second polymer can be added without significant changes to the thermal characteristics of the base polymer. This means in particular that the application temperatures currently known for the base polymer—for example in the extruder or in the spinplates—do not need to be changed significantly, and a currently stable manufacturing process with the base polymer remains stable despite the addition. If, however, a change of a thermal characteristic of the base polymer like the melting point, for example, the softening temperature or crystallization temperature is desired, this can be achieved by further addition of other additives or polymers.

On the other hand, the addition of the second polymer to the base polymer can be used to change a crystallinity. This crystallinity can be decreased by adding the second polymer. The crystallinity can be calculated based on the heat transfer in the form of the enthalpy Delta H (melting or consolidating enthalpy). By adding 10 weight percent Affinity EG8200 as second polymer to the base polymer, the crystallinity was reduced by about 10%, for example. It follows that less melting enthalpy is involved to laminate the nonwoven to another layer in a thermobonding step, for example.

One especially preferred application results for a nonwoven material or a nonwoven fiber manufactured from such polymer mixture, if the nonwoven material or the nonwoven fiber is configured between two layers and creates a bond with the two layers through application of heat. This nonwoven material or this nonwoven fiber created from a polymer mixture will be preferably used as bonding agent between two layers.

A nonwoven material or a nonwoven fiber from such a polymer mixture has the additional advantage of increasing an elongation (expansion) characteristic of the nonwoven material or the nonwoven fiber. Pursuant to one embodiment it is provided, for example, that an LLDPE, in particular to increase the elongation characteristics of a nonwoven fiber as described above, is preferably used as base polymer in an above-described polyethylene.

An advanced embodiment provides that a bond with a first, a second and a third layer is created. The second layer is configured between the first and the third layer. The layers are expanded and exposed to heat. Preferably, the layers are simultaneously also exposed to pressure. The second layer develops in this case a bonding characteristic towards the first and towards the second layer.

This allows a bond to be created between the first and the third layer. With this method, several layers could be placed into a mold, be expanded together under application of pressure and heat and thus being molded and fused together. In particular, this method offers the possibility that the geometry of a nonwoven fiber and/or such nonwoven material based on this type of polymer mixture dissolves in the presence of heat. If nonwoven of this type or a nonwoven fiber of this type is used as a substitute of a hot-melt material, the application of pressure and heat can lead to the fact that after the application of pressure and heat only the resulting polymer mixture of the nonwoven material or of the fiber remains but the geometry of the nonwoven material or the nonwoven fiber has been dissolved.

Another field of application of the nonwoven material or a nonwoven fiber from this type of polymer mixture is a thermoforming process. In this process, the nonwoven is inserted into a thermoforming mold. A stamp pushes the layered material into the thermoforming mold and creates a bond from the layer material in the mold. The purpose of the nonwoven or the nonwoven fibers being used is one hand to create an adhesive layer, which creates a strong bond between adjacent layers, so that such bond can be broken only under application of strong tearing forces. On the other hand, the above described increase of the expansion characteristic by way of the second polymer on the polymer is being leveraged. The nonwoven material or the nonwoven fiber can be used for the manufacture of carpets, in particular vehicle carpeting, covers or other items, for example.

One embodiment provides, for example, that the nonwoven material is placed between a first layer of a first polymer material and a second layer of a second polymer material. The first polymer material and the second polymer material are both different and preferably exhibit different softening and melting temperature characteristics, which generally prevents a bond between the two polymer materials or only provides an insufficient mutual bond. It may be provided, for example, for the first layer to be of an EVA or exhibits EVA at the surface, while the second layer exhibits PET or is made of PET. The second layer may be a velour carpet, for example, while the first layer may be a heavy layer. By bonding under pressure and heat, the nonwoven material or the nonwoven fiber will at least become sticky, may after especially long application of pressure and heat dissolve, and thus create either a full-service bond or a discontinuous bond between the both layers.

Another sample application for the nonwoven material or the nonwoven fiber is the manufacture of acoustics components as may be used in vehicles, for example. However, they can also be used in other areas, like for acoustic insulation or for targeted sound shaping of spaces like opera auditoriums, theater auditoriums, cinema auditoriums and similar event auditoriums (halls). Living rooms or other rooms with desired acoustic properties may also be treated with this type of material. In these cases, a type of needle felt would be used, preferably a needle felt with a weight between 40 and 150 g/m². The backside of the needle felt is used to bond the needle felt to an acoustic foam or any other insulating material, for example. This may also be a so-called rip-nonwoven, which is made of shredded old clothes.

A nonwoven material manufactured with the proposed polymer mixture is thermally bonded by application of pressure and heat. This may be done with a calandering process. A sample for this is disclosed in U.S. Pat. No. 3,855,046. Instead of thermobonding there is the possibility that the nonwoven material achieves stability (sturdiness) also through spunlacing (hydroentanglement). In this context we refer to U.S. Pat. Nos. 4,021,284 as well as 4,024,612. In order to be able to pre-stretch the nonwoven, the nonwoven may also be stretched in MD direction as well as in CD direction. The MD direction is the machine direction and the CD direction is the traverse direction. The material can be stretched simultaneously or time-sequentially into both directions. Embodiments for the respective devices for this purpose are obtainable from U.S. Pat. No. 4,110,892, U.S. Pat. No. 4,834,741, U.S. Pat. No. 5,143,679, U.S. Pat. No. 5,156,793, U.S. Pat. No. 5,167,897, U.S. Pat. No. 5,422,172 as well as U.S. Pat. No. 5,518,801.

The nonwoven is preferably manufactured as a single layer and sold to other customers. There is, however, the other possibility that the nonwoven will be manufactured as a laminate with at least one additional layer. This layer may also be a nonwoven. It can also be utilized as foil. The layers can be thermally bonded, glued or connected to each other by other appropriate means. Spray adhesives, for example, so-called hot-melt glues, latexbased glues or other glues may be used. The bonding process may furthermore occur with ultrasound waves or water jets. This can be obtained from WO 02/055778 A1, for example. There is also the option of needling the layers together. Different layers can also placed on top of each other and bonded to each other, while at least one of the layers is still in bondable condition. Different methods as well as systems for laminating are disclosed in U.S. Pat. No. 6,013,151 as well as U.S. Pat. No. 5,932,497, for example.

The polymer can initially be created inside an extruder, whereby for this purpose the extruder exhibits a first and a second feed for one polymer each. Other additives and extras can be added to the polymer mixture. Twin worm extruders can be used, for example, to manufacture the polymer mixture when it is desired for the manufacture of nonwoven fibers. Another embodiment provided that the polymer mixture is pre-manufactured in batches and supplied (fed) into the extruder in this form.

There is furthermore the option to use the proposed polymer mixture to manufacture an especially soft nonwoven material. For example, for this purpose a manufacturing process can be used as disclosed in WO 02/312 45 A2. Furthermore, the nonwoven can also be manufactured to exhibit thermally reversible and thermally non-reversible bonds as disclosed in US 20050037 194 A.

There is the other option to use the polymer mixture to manufacture an SM or SMS material as proposed in U.S. Pat. No. 5,178,931 or U.S. Pat. No. 5,188,885, wherein a so-called melt-blown material according to U.S. Pat. No. 3,704,198 and U.S. Pat. No. 3,849,241 can be made.

There is the further option to manufacture a bi-component fiber, which exhibits the primary mixture. The bi-component fiber may exhibit a core-sheath structure or any other structure with clearly defined areas of different polymers or polymer mixtures.

The nonwoven material or the nonwoven fiber can also be used as nonwoven foil laminate. The foil may, for example, have one or more layers, wherein the side of the foil facing the nonwoven exhibits a polyethylene. This creates an especially secure bond between the two outer surfaces of the foil and the nonwoven.

From DE 10 2005 048 443 follow different applications and samples of such laminates as well as information about possible methods of fabrication. Various additives that can be used advantageously are also referenced. A bond between foil and nonwoven can also be supported with electrostatic charges.

A system for the manufacture of a spundbond nonwoven is proposed in WO 05/040474 A1, for example. In this system, the nonwoven deposit is supported by the fact that an electrostatic charge is used in addition to the effect of a diffuser. Another manufacturing method for the manufacture of spunbond filaments, from which the nonwoven is created, can be obtained from WO 04/020722 A2.

Due to its properties, nonwovens can be utilized in various applications, which shall be listed here as samples only without claiming to be exhaustive: in the medical field, for example for stoma-bags, covers, white coats and smocks, face masks, feminine and baby hygiene items, for example as “back sheet” or as “top sheet”, which may also exhibit a coating, for diapers, feminine pads, adult incontinence items, as printing support, protective surface, as packaging material, as separator, as vapor-permeable or watertight material, as adhesive material for use in micro loop and hook-type closures, for example through provision of regions with loops by shaping the nonwoven accordingly, as fastener material for locking systems, as contact surface for adhesives, as contact agent between two surfaces between a bed and an overlay, for example, as part of a wall cover or wall paper or floor material, as cleaning or polishing items, in protective closing like for an overall, for applications close to the skin. As oil and/or grease absorbents and/or cleaning agents, in athletic clothing, athletic accessories and/or athletic gear and shoes, in clothing like gloves, jackets or similar items; as packaging for bottles, for example; in jewel cases for CD's; as sheathing; as decoration; in the automotive industry, for instruments, as lining material for the covering of items; as coating, in roofing materials; as roof lining sheets or part thereof; as house wrap, as building material, as roofing membrane or lower deck lining; as wall cover, for new construction, for restorations, roof recovering, roof extensions; as water, vapor or air barrier and/or facade sheeting; usable in single or multiple layers, as strips in order to achieve specific coverings in the area of the roof, for example; as carrier substrate; as part of carpets or other floor coverings, as noise and/or heat insulation; as filtering agent; as sedimentation agent; as identification, e.g. for the application of lotion; for the storage of substances, which will be released slowly or at once during use, for example through diffusion release; as cleaning cloth for eyeglasses; as loading material for seeds and/or powders; as intermediate layer in an article of personal hygiene, sanitary items, e.g. in a towel, in bathing caps; drainage means; as color marking, as signal marking, as slip cover, as wound cover material, in elastic bandages; as cigarette filters; as surface material for throw-away or single-use items; as cover material for painting, coating and other processes; for the cultivation of cell cultures; for elastic materials, items of personal hygiene as sidebands, waistbands, and/or elastic closures; for suction pads, and other applications.

The different applications involve different additives to ensure that the nonwoven and/or the laminate containing the nonwoven provides the properties desired for the respective application. For example, additional UV stabilizers can be mixed in. Preferably added is a weight portion of at least 1 weight percent to 5 weight percent of UV stabilizers. Preferred is a UV stabilizer with CAS # 193098-40-7 and/or 067845-93-6. For example, a UV absorber, HALS stabilizer and/or a so-called quencher can be used as UV stabilizers. A UV absorber filters the ultraviolet wave spectrum from the light. The energy of the absorbed light is converted into heat. The degree of UV absorption depends on the concentration of an active substance and the wall thickness of the final product. Benzophenes, triazoles and trazines can be used as UV absorbers. Used as HALS stabilizers (hindered amine light stabilizers) are additives, which prevent the reaction of aggressive photo-oxidation products, in particular of radicals and peroxides. Adjustments to the active substance concentration can be used to determine the product lifecycle of the nonwoven and/or the laminate. HALS stabilizers can be polymeric HALS, oligomeric HALS, NOR-HALS and/or HALS substitutes. A quencher deactivates radicals and finally dissipates energy in the form of heat. It is known, for example, that nickel can be used as such a quencher. In addition to these UV stabilizers, the nonwoven can preferably be equipped with additional thermal stabilizers. Thermal stabilizers are preferably antioxidants which are able to protect the polyethylene being already used during processing. The thermal stabilizers and the UV stabilizers are added to the polymer in the form of a master batch. Samples of thermal stabilizers are phenols or phosphites.

The disclosure further refers to UV stabilizers as described in U.S. Pat. No. 6,100,208, as well as to the polymer mixtures described there with the accordingly adjusted UV stabilizers and the respective weights and pigments for nonwoven fibers. This disclosure is being included into this description.

UV stabilization is increased further by increasing the titanium dioxidan part in a polymer. As a sample, provided may be a titanium dioxidan content of more than 5 weight percent of a nonwoven. Preferably, the first layer exhibits a nonwoven fiber with such a titanium dioxide content. A further increase of UV stability results from the use of a reflectant in at least one of the layers of the laminates. For this purpose, a metal coating and/or a metal layer may be provided, in particular in the form of a foil worked into the laminate. Another embodiment provides that metal particles with strong reflective properties are provided on at least one surface. UV stability is increased further by the use of soot particles, in particular in conjunction with polyethylene. The soot particles in the polyethylene material make the polyethylene less vulnerable to UV rays.

There is the other option of electrostatically charging the nonwoven using additiviation, for example. The nonwoven can also be utilized as electrical insulator but also as an electrical conductor by adding an electrically conductive substance. The nonwoven can also be used as a filter, especially as an inside filter, for example as one layer of many for the filtering out of coarse particles and/or the bonding of different layers.

### BRIEF DESCRIPTION OF THE DRAWINGS

Additional advantageous embodiments and characteristics will be explained respectively in greater detail based on the following figures. The samples shown in the figures shall not be interpreted to be limited but to be samples-only. The characteristics described below can also be linked to characteristics of the other figures as well as to characteristics of the other figures as well as to characteristics of the disclosures described above. In the figures:

FIG. 1 shows a first spinning system operating according to a first process for the manufacture of a spunbond nonwoven;

FIG. 2 shows a second system for the manufacture of a spunbond nonwoven;

FIG. 3 shows a thermoforming process using the nonwoven as composite adhesive sheet;

FIG. 4 shows a sectional view of the first product;

FIG. 5 shows another sectional view of a second first product;

FIG. 6 shows a cross-sectional view of a nonwoven fiber;

FIGS. 7-9 show cross-sectional views of a bicomponent fiber; and

FIG. 10 shows a diagram 1 mit temperature reading pursuant to DSC curves.

### DETAILED DESCRIPTION

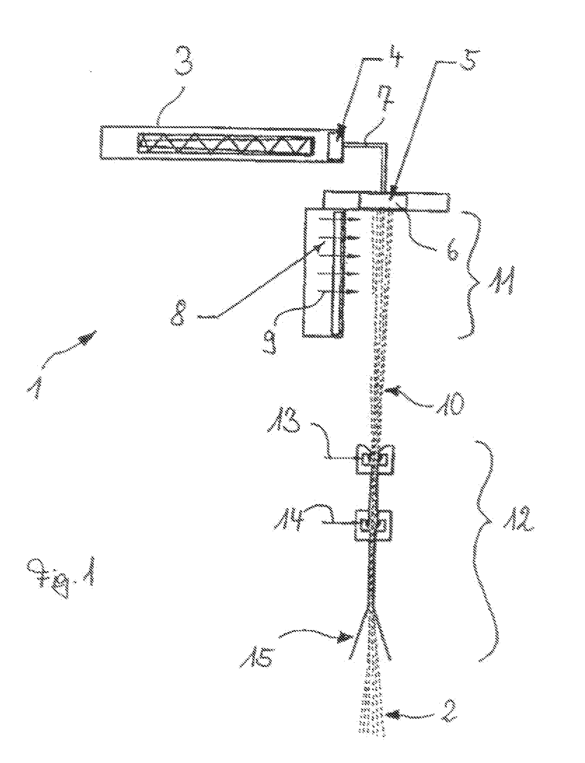

FIG. 1 shows a first system 1 for the manufacture of proposed nonwoven fibers 2. A batch of polymer mixture is fed into the system via an extruder 3, melted and fed into a spin pack 5 through the extrusion head 4. The extrusion head 4 and the spin pack 5 can be heated separately. Located inside the spin pack 5 is a spinneret plate 6. The polymer 7 coming from the extruder is pressed through the spinneret plate 6. After exiting the spinneret plate 6 the polymer 7 continues in the form of individual strings or filaments and is cooled down by a quencher 8 and drawn out.

The quencher provides that a quenching medium 9 (suggested by the arrows) cools the polymer filaments 10 drawn from the spinneret plate 6. After moving through this single-part quenching section 11, the polymer filaments 10 are routed into a gap 12. In the gap 12, a driving medium 13 is introduced first. This medium may, in particular, be propellant air. At a distance, a spreader medium 14 is introduced which is used to force the polymer filaments 10 apart in a subsequent diffusor section 15. The spreading can in addition be supported by an electric charge. The drawn and spread nonwoven fibers 16 can then be placed onto an interim storage surface, which is here not explained in greater detail, and continued to be processed. The shown system and the selected parameters allow the manufacture of the nonwoven described above. For this purpose, a bonding device is added after the first device 1, in particular a calander device, so that the nonwoven can be produced in one process from the melting of the polymer and further processing of the nonwoven fibers all the way to the hardening through the calendar device without additional steps.

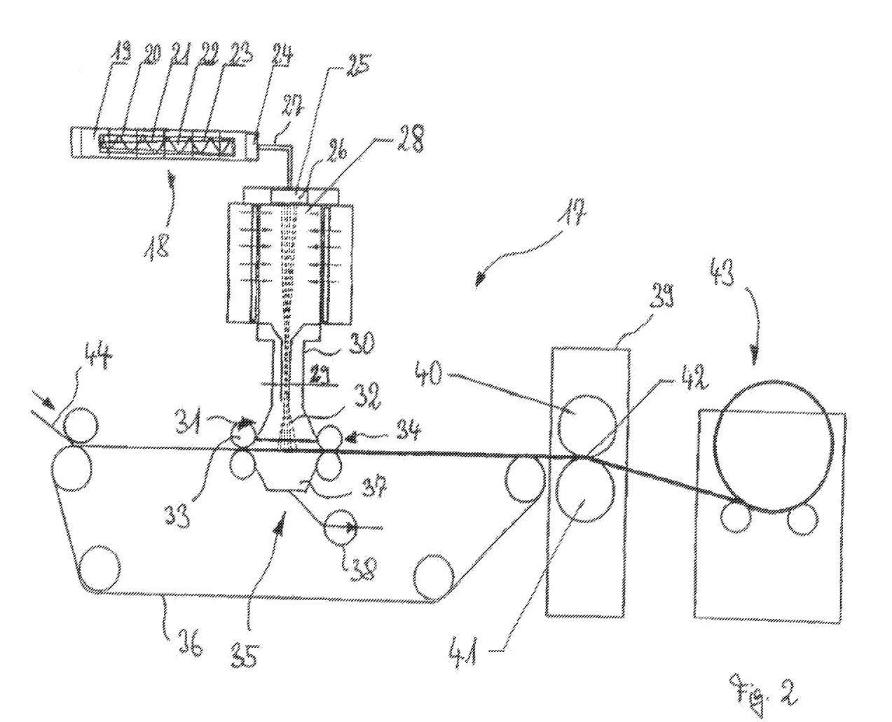

FIG. 2 shows a second device 17 exhibiting an extruder 18. The extruder 18 has a first section 19, a second section 20, a third section 21, a fourth section 22, and a fifth section 23. Sections 19 to 23 can be heated to different temperatures. The extruder 18 furthermore exhibits a heated extrusion head 24. The extrusion head supplies the melted polymer under appropriate conditions to the spin pack 25. Via the spin pack 25 and the via the spinneret plate 26 contained inside the spin pack 25 the pressurized polymer 27 is fed into a chamber 28. The chamber 28 exhibits an exit opposite of the spin pack 25.

The exit may be designed in the shape of gap as shown in the figure. In particular an adjustable width 29 of the gap can be set. The exit 28 end in an enclosure 30 which preferably exhibits a diffusor section 31. The diffusor section 31 forces the nonwoven fibers 32 apart when placed on the interim staging device. Provided upstream or downstream from the diffusor section 31 may be an electrostatic charge. This charge can also be integrated into the diffusor and support the spreading. Adjacent to the diffusor section and in particular preferably also sealing are a first roller section 33 and a second roller section 34. Roller sections 33, 34 are preferable designed such that improved suctioning of the quenching medium through the staging section 35 is possible. The suction 37 can in particular be located underneath a screening belt 36 of the staging section 35. The suction 37 can preferably adjusted to different exhaust volumes by changing a suction device 38. The staged nonwovens 32 are then compressed by a calander 39, in particular, thermobonded. For this purpose, the calander 39 exhibits an embossing roll 40 and a smooth roll 41. The embossing roll 40 and the smooth roll 41 form an embossing gap 42, wherein the line pressure inside the gap is adjustable. The nonwoven material is reeled by a subsequent reeling device 43 and stored or further processed in the form of drums. On the screen belt 36, an unwinder (not shown) or another layer manufacturing device may be located upstream from the second section 17. In an in-line process, this would allow a support surface 44 to be introduced, on which the spunbound nonwoven can be placed and then bonded. This might be a foil, another nonwoven or even another layer.

FIG. 3 shows a sample embodiment of a pressing apparatus 45, in which is 46 composed of a polymer mixture is inserted between a first layer 47 and a third layer 48 as second layer 49. These layers may preferably be laminated to each other. They may, however, also be fed into the apparatus individually with the pressing process creating a tear-resistant bond. By applying heat and pressure via a pressure stamp 50, whose travel path is suggested by arrows, changes in temperature and pressure can be used to control if the nonwoven material 46 or the nonwoven fibers remain partially intact or if the nonwoven completely dissolves, thereby creating an adhesive bond between the first and the third layer.

This suggested schematically by the dissolution of the second layer, which is removed from the pressing apparatus in the form of the schematically suggested thermoforming apparatus.

Advantageous for the use of the nonwoven is the fact that in a thermoforming process as the one schematically shown, the nonwoven 46 is able to follow the two outer layers while they are being stretched. This prevents the creation of low-adhesion points which result when the nonwoven is torn. Instead, the good stretching characteristics of the nonwoven allow the creation of an adhesive bond across the entire surface. The product manufactured with the nonwoven 46 can be used for automotive applications like coverings, thermal insulator as well as damping material. The nonwoven can, of course, also be used in sanitary items, for example as the layer which may come in contact with the skin.

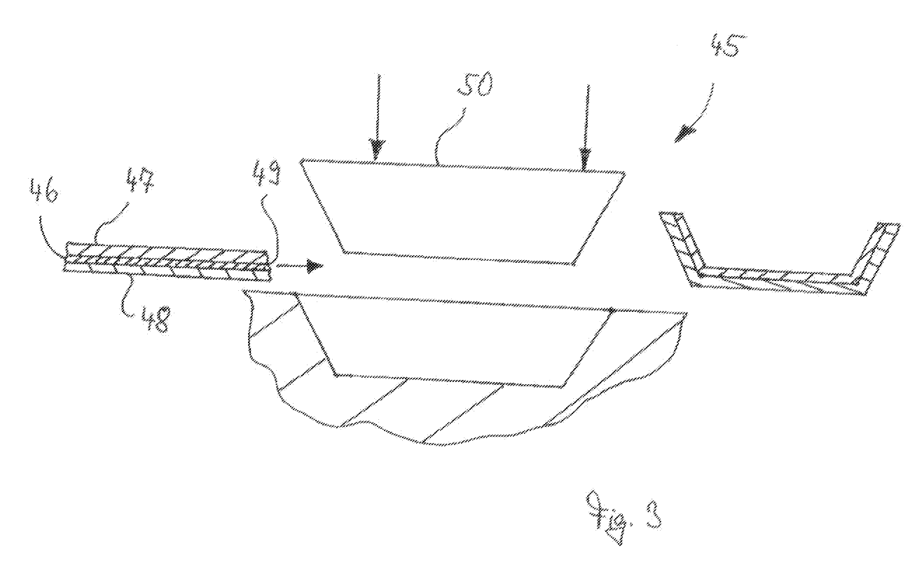

FIG. 4 shows a section of a first product 51. Product 51 exhibits a proposed polyethylene nonwoven 52 at its surface 53. The product may be a dual-layer material, as shown. This laminate can be foil/nonwoven laminate, for example.

FIG. 5 shows a section of a second product 54. The second product 54 is an SMS material, for example, who layers have been thermobonded. Preferably, the layers were bonded not only with each other but also individually embossed. At least one of the spunbond layers is a nonwoven with a polyethylene surface.

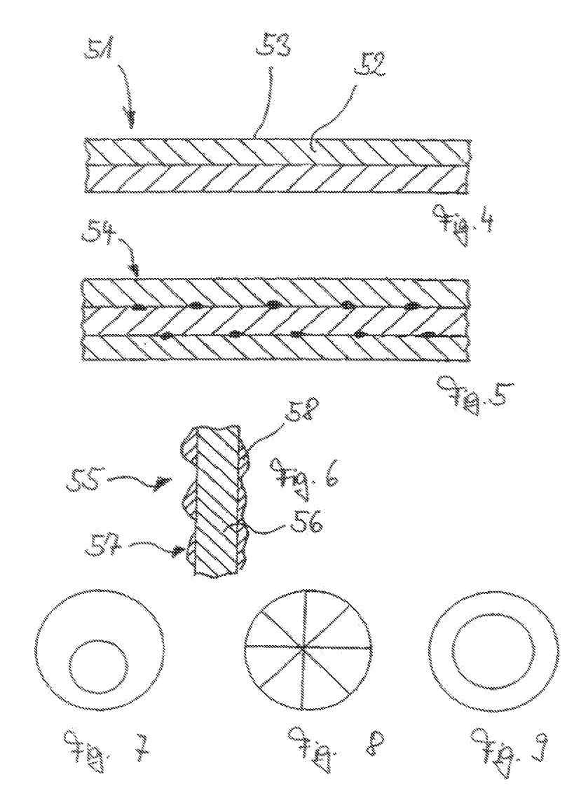

FIG. 6 shows a cross-sectional view of a nonwoven fiber 55. It exhibits a core 56, preferably 20 containing another polymer like polypropylene, for example. A surface 57 of the nonwoven fiber at least partially exhibits the polyethylene mixture. The polyethylene can covet the entire core 56 as a coating 58 or intermittently, especially in the case of a changing Surface geometry. If interruptions are present, they may be advantageously provided with an oxidation layer for thermobonding, for example.

FIGS. 7-9 each shows different cross-sectional views of bicomponent fibers. In addition to the full-surface fiber of the proposed polyethylene material, the bicomponent fiber offers the advantage of allowing desired characteristics of the nonwoven, like the tensile strength, to be controlled by targeted selection of the other polymers. In the shown fiber, the polyethylene mixture creates at least a partial, in particular, a full surface.

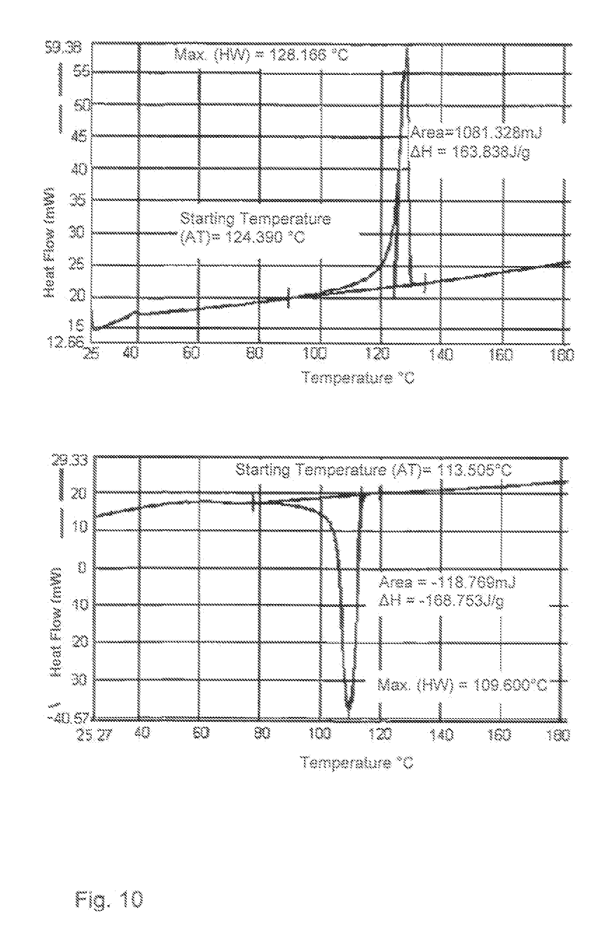

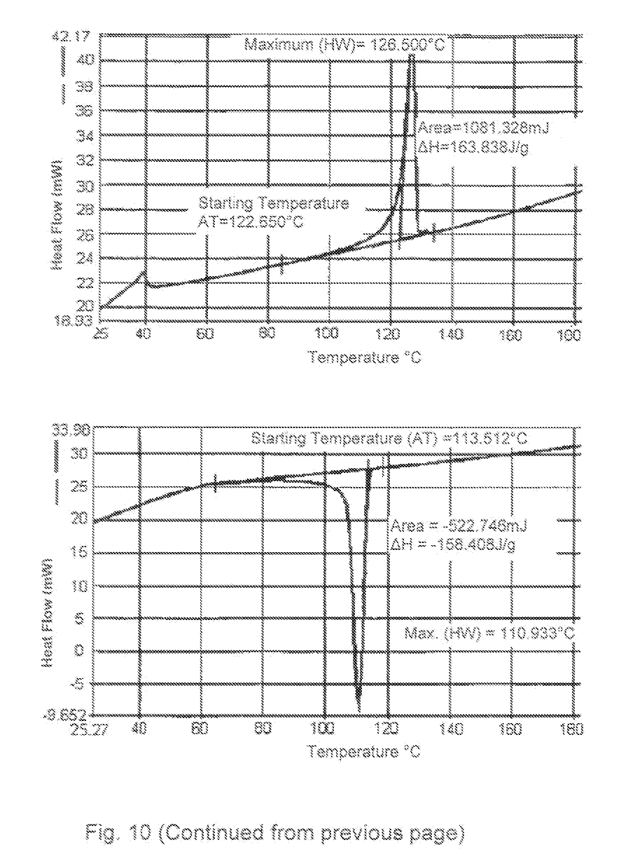

FIG. 10 shows a representation 1 of temperature measurements pursuant to DSC curves. Representation 1: DSC Chromatogram of filaments made exclusively from the base polyethylene (top), and from the base polyethylene 10 weight percent of Affinity EG8200 (bottom). First heating (left) and cooling curve (right).

What is claimed is:

1. An article, comprising:
a plurality of nonwoven fibers, at least some of the fibers comprising a polymer mixture that comprises:
a polyethyelene as a first polymer; and
a LLDPE as a second polymer,
wherein:
the first polymer has an MFI between 15 and 35 g/10 min per ISO 1133;
the first polymer has a density of 0.935 to 0.965 g/cm³ per ASTM D-792; and
the second polymer has a density between 0.85 and 0.900 g/cm³ per ASTM D-762.

2. The article of claim 1, wherein the polymer mixture comprises at least 80 weight percent of the first polymer, and the polymer mixture comprises from 10 to 20 weight percent of the second polymer.

3. The article of claim 1, wherein the second polymer has an MFI of 3 to 7 g/10 min per ISO 1133.

4. The article of claim 1, wherein the second polymer has a melting point of from 50° C. to 100° C. per DSC measurement.

5. The article material of claim wherein the second polymer is an ethylene alpha olefin copolymer.

6. The article of claim 1, wherein the polymer mixture comprises a polyethylene homopolymer or a polyethyelene copolymer.

7. The article of claim 1, wherein the article comprises two layers that bond to each other upon the application of heat.

8. A fiber, comprising:
a polyethylene as a first polymer, the first polymer having an MFI of between 15 and 35 g/10 min per ISO 1133, and the first polymer having a density of 0.935 to 0.965 g/cm³ per ASTM D-792; and
an LLDPE as a second polymer, the second polymer having a density between 0.85 and 0.900 g/cm³ per ASTM D-762.

9. The fiber of claim 8, wherein the fiber comprises at least 80 weight percent of the first polymer, and the fiber comprises up to 20 weight percent of the second polymer.

10. The fiber of claim 8, wherein the second polymer has an MFI of 3 to 7 g/10 min per ISO 1133.

11. The fiber of claim 8, wherein the second polymer has a melting point of from 50° C. to 100° C. per DSC measurement.

12. The fiber of claim 8, wherein the second polymer is an ethylene alpha olefin copolymer.

13. The fiber of claim 8, wherein the fiber comprises a polyethylene homopolymer and/or a polyethylene copolymer.

14. A polymer mixture, comprising:
a polyethylene as a first polymer, the first polymer having an MFI between 15 and 35 g/10 min per ISO 1133, and the first polymer having density of 0.935 to 0.965 g/cm³ per ASTM D-792; and
an LLDPE as a second polymer, the second polymer having a density of 0.85 to 0.900 g/cm³ per ASTM D-762.

15. The polymer mixture of claim 14, wherein the polymer mixture comprises at least 80 weight percent of the first polymer, and the polymer mixture comprises up to 20 weight percent of the second polymer.

16. The polymer mixture of claim 14, wherein the second polymer has an MFI of 3 to 7 g/10 min per ISO 1133.

17. The polymer mixture of claim 14, wherein the second polymer has a melting point of from 50° C. to 100° C. per DSC measurement.

18. The polymer mixture of claim 14, wherein the second polymer has a melting point of from 50° C. to 70° C. per DSC measurement.

19. The polymer mixture of claim 14, wherein the second polymer is an ethylene alpha olefin copolymer.

20. The polymer mixture of claim 14, wherein the polymer mixture comprises a polyethylene homopolymer and/or a polyethylene copolymer.
